(19) United States
(12) Patent Application Publication
(10) Pub. No.: US 2008/0247852 A1
(43) Pub. Date: Oct. 9, 2008

(54) Side-lift trailer

(76) Inventor: Michael Graham, Fayetteville, AR (US)

Correspondence Address: KEISLING PIEPER & SCOTT PLC, Suite 340, 3739 Steele Blvd., Fayetteville, AR, 72703, US

(21) Appl. No.: 11/818,130

(22) Filed: Jun. 13, 2007

Related U.S. Application Data
(60) Provisional application No. 60/804,636, filed on Jun. 13, 2006.

(51) Int. Cl. B65G 67/42; G09F 21/04

(52) U.S. Cl. 414/483; 40/591

(57) ABSTRACT

A load hauling vehicle such as a truck or trailer having a bed which can be loaded or unloaded either from the side or the rear of the bed. The present invention has one or both side walls which are hinged at the bottom edge to an adjacent edge of the bottom of the bed so that the side walls can be swung by an actuator to raise and lower the side walls. The present invention further provides a mobile display with at least one secondary lifting arm that raises an advertisement to be prominently displayed to potential customers. Further, the side walls of the present invention can serve as a portable stage.

### CROSS-REFERENCE TO RELATED APPLICATIONS

This application claims priority to and is a continuation-in-part of U.S. application Ser. No. 60/804,636, filed Jun. 13, 2006.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

1. Field of the Invention

The present invention relates to load hauling vehicles such as trucks or towable trailers which may be towed by towing vehicles and in particular to vehicles having beds which can be loaded or unloaded from the side of the bed.

The present invention provides one or two side walls which are hinged at the bottom edge to an adjacent edge of the bottom of the trailer so that the side walls can be swung from an upwardly extending closed position, storage position, for storing transported items to a downwardly extending open position, load position, for loading, unloading, or displaying the transported items. The present invention utilizes a lifting arm that is capable of adjusting the side wall from a load position to a storage position while the side wall is loaded with transported items. Further, the lifting arm of the present invention maintains the side wall in the storage position while transported items are stored within the present invention. Known art may be found in U.S. Class 410, Subclass 93 and U.S. Class 414, Subclass 467, 545, 680, and other relevant areas.

II. Description of the Known Art

The known art has addressed some issues with load hauling devices.

U.S. Pat. No. 6,382,731 (the '731 patent) issued to Slutz et al. on May 7, 2002 discloses a load carrying vehicle such as a truck or trailer which has a chassis; a bed mounted on top of the chassis; the bed having a bed bottom, a front end having a front end wall, a pair of opposed side walls, and a rear end having a rear door hingedly attached to the bed to permit it to be opened; at least one of the side walls having a lower edge hingedly connected by a hinge means to an adjacent edge of the bed bottom to permit the side wall to be opened downwardly to provide side access to the bed for side loading and unloading; a side wall actuator means mounted adjacent to the hinge means; and a linkage means pivotally connecting the side wall actuator means and at least one side wall to cause the side wall to move back and forth between an upwardly extending closed position and a downwardly extending open position.

U.S. Pat. No. 4,106,812 issued to Clark on Aug. 15, 1978 teaches a side dumping vehicle having pivotally interconnected bottom walls and side walls which may be displaced between a trough shaped configuration in cross section and an inverted “V” configuration in cross section. In changing the configuration from that of a trough to that of an inverted “V”, a load carried by the vehicle is dumped on both sides thereof.

U.S. Pat. No. 4,242,031 (“the '031 patent”) issued to McMullen on Dec. 30, 1980 discloses an apparatus for side loading and unloading large objects such as cylindrical fuel tanks from flat bed trailers. Double pivoted links in combination with a bent lever permits lateral loading and unloading from a plane below the level of the trailer bed.

U.S. Pat. No. 4,826,237 (“the '237 patent”) issued to Socha on May 2, 1989 discloses a dump body that includes opposite hinged side doors and a hinged rear door. The side doors include a latch assembly and are particularly adapted to shed material in their down positions during unloading when the dump body is level so that the side doors can then be raised and positively secured in their up positions without manual cleaning.

Referring now to FIGS. 2 and 3 of the '237 patent, the '237 patent teaches a pivotal side door between each front corner post and the associated rear corner post on each side of the dump body. In particular, each side door is pivotally secured at its bottom end by hinges to the side edges of the floor or bottom wall for swinging movement over about 180 degrees as shown, between an up position and a down position. The up position of one of the side doors is shown in solid lines in FIG. 2 of the '237 patent, with its down position being shown in phantom lines.

U.S. Pat. No. 4,627,784 (the '784 patent) issued to Collins on Dec. 9, 1986 teaches parallel spaced posts that are rigidly connected by a cross member to form an H-shaped frame, and the frame is supported by carriage members within tracts for linear and tilting movement between a storage position under the floor of a vehicle body and a vertical operating position adjacent a doorway within a side wall of the body. The posts support movable intermediate tracks which support movable elevator members carrying a platform pivotable between an extended horizontal position and a retracted storage position adjacent the posts. Hydraulic cylinders move the frame between its storage and operating positions and also move the elevator members and platform vertically between a bottom position on the ground and an upper position flush with the floor of the body.

The '784 patent discloses an invention that is directed to a power operated loading and unloading apparatus adapted for use on a wheel-supported vehicle such as an enclosed truck or trailer body and which is ideally suited to be mounted under a frameless body and used for loading and unloading articles through a side doorway within the body. The apparatus taught by the '784 patent is also constructed for loading and unloading loads of substantial weight and size and for storage in a retracted position under the bed or floor of the body without increasing the overall width of the body. The loading apparatus taught by the '784 patent further provides for accommodating outwardly pivoting doors mounted on a side wall of the body and for smooth vertical movement of a load support platform between a lower position resting on the ground and an elevated upper position where the platform is flush with the floor surface of the vehicle body.

U.S. Pat. No. 7,207,631 (“the '631 patent”) issued to Schwinbt on Apr. 24, 2007 teaches a side discharge bulk material trailer that includes a frame with two I-beam members. The '631 patent further teaches a plurality of A-frame members that are attached to the I-beams. A fore and aft extending tube is attached to the apex of each A-frame. Floor plates are attached the upward facing surfaces of the legs of the A-frames. A front wall and a rear wall are attached to the frame. Upper doors and lower doors are provided in the side walls. The lower doors have a lower edge pivotally connected to the frame for pivotal movement about a horizontal axis. The upper doors have a top edge pivotally attached to the end walls for pivotal movement about a horizontal axis. Hydraulic cylinders pivot the doors to open and closed positions. Locks retain the lower doors in a closed position. The lower doors hold the upper doors closed.

While some devices have attempted to allow a user to load a trailer from the side, none of these devices provide sufficient force to allow the side walls of the trailer to support the load as the load is transferred into the trailer. The known art does not teach side walls capable of lifting the transported items such that the transported items are transferred from outside the trailer to inside the trailer through the side by raising the side walls from a load position to a storage position.

Trailers of the past required users to load transported items at the back of the trailer and gradually load items towards the trailer door to maximize the storage capacity. This method of loading a trailer required a user to organize the best method of loading a trailer to maximize loading capacity and to ensure access to particular items so that the items can be unloaded at the proper time. As trailers have improved, trailers have developed such that they can now be loaded from the side to simplify the loading process such that a user did not have not have to load the trailer from the back or the top. However, the known side-loading trailers do not provide a user with the capability of using the side walls to load the trailer. The side walls of the present invention allow a user to maximize storage efficiency by securing transported items to the side wall.

Further, the known art does not teach securing the transported items to the side wall such that transported items can be raised from a load position to a storage position. Further, the known art does not teach side walls that remain in a storage position while the side walls are supporting the weight of transported items.

The trailer of the present invention is particularly useful in hauling different types of cargo. The present trailer has a long bed which is especially useful in hauling elongated objects which may extend the full length of the bed. Such objects are loaded and unloaded by swinging down the side wall to provide access such that material handling equipment can be used to transfer the load.

The method of loading the present invention allows users to load the trailer by placing transported items onto the side wall when the side wall is in a load position, raising the side wall to a storage position, and securing the side wall such that that the side wall cannot be lowered while the present invention is in motion. At the loading and unloading points, a loading platform of side wall is lowered so that a user can load and/or unload the transported items from the side wall. Since side walls can support large loads such as multiple spas, the present invention provides a sturdy side wall attached to a actuator, such as a hydraulics system, that raises and lowers the side wall to transfer items from a load position to a storage position and from a storage position to a load position. Further, the present invention provides a securing arm that provides a fastening system that secures the spas or other transported items to the side wall.

The trailers disclosed in the known art are not capable of lifting the weight of the transported goods from a load position to a storage position. Further, the trailers disclosed in the known art are not capable of applying adequate pressure on the side walls to maintain each side wall in the storage position while goods are secured to the side walls. Thus, the present invention directs itself to an improved side-lift trailer system that is safer to use and that functions more efficiently by allowing a user to easily assemble a portable display for selling goods or to easily assemble a portable stage. Thus, a perceived need exists in the art for an improved side lift trailer. It is, therefore, an object of the present invention to eliminate the problems inherent with existing known trailers.

### SUMMARY OF THE INVENTION

The present invention is a load carrying vehicle such as a truck or trailer which has a bed having a bed bottom and at least one side wall; the side wall having a lower edge hingedly connected to an adjacent edge of the bed bottom to permit the side wall to be opened downwardly to provide side access to the bed for side loading and unloading.

The present invention provides at least one side wall attached to a lifting arm connected to a lifting system that allows for the side wall to be raised to a storage position or lowered to a load or display position. The side wall of the present invention provides a user with a portable point of sale display for goods stored within the trailer. In one embodiment, the present invention is designed to provide a portable point of sale display for large items such as spas. A user simply loads the trailer with the goods to be sold. The user then locates an area to assemble a mobile display from which the user of the present invention can advertise and sell the goods.

The present invention allows a user to increase sales by increasing the areas in which a user can establish a point of sale display for the goods. Instead of providing a magazine, brochure, or advertisement describing the goods, a user of the present invention actually shows the goods to an increased number of users by providing a mobile display for the goods that a user can display in high traffic areas in which potential customers will be located. A user of the present invention is no longer limited to displaying the actual goods in only showrooms.

To assemble the mobile point of sale display, a user parks the trailer in a desired location. In one embodiment, a user lowers at least one stabilizer to assist in the stabilization of the trailer while the side wall is lowered to the load position. A user then actuates the lifting system that gradually lowers at least one side wall while supporting the side wall such that the side wall is lowered at an adequate rate that prevents accidental damage of the goods stored on the side wall. In one embodiment of the present invention, the present invention provides advertising displays stored within the storage area of the trailer that provides a user with a simplified method of attracting customers while removing the hardships of displaying the advertisements and banners that attract potential customers.

To relocate the point of sale display, a user simply activates the lifting system to raise the side walls while the side walls are loaded with the goods. The lifting system supports the side walls such that the goods will remain secured to the side walls while the goods are transferred to the storage area of the present invention. After the side walls are adjusted to the storage position, a user raises the stabilizers. The user can then freely transport the present invention to another location.

In another embodiment, the present invention provides a portable stage that easily assembles. Instead of storing goods on the side walls, the side walls remain empty to allow the side wall to serve as a stage floor. In one embodiment of the portable stage, the stabilizers are again utilized to stabilize the present invention while the portable stage is in use. While the present invention is used as a portable stage, the lifting system is adapted to support the weight required to maintain each side wall level with the bed of the trailer.

It is an object of the present invention to provide a vehicle which is designed to carry multiple types of cargo which may be either elongated items or loose aggregate materials.

Another object of the present invention is to provide a vehicle which can be loaded and unloaded by either the side or from the rear of the trailer bed.

A still further object of the present invention is to provide a vehicle in which long side walls can be swung upwardly and downwardly by a lifting system.

An even further object of the present invention is to provide a vehicle having a power operated latch on the end of the side wall to secure the side wall in a closed position when a load is to be hauled.

It is a further object of the present invention to provide a portable display from which a user may advertise and sell goods, including spas, to potential customers.

It is an object of the present invention to allow quick assembly and disassembly of a portable display from which goods may be sold.

It is a further object of the present invention to provide a portable stage.

It is a further object of the present invention to allow a user to quickly assemble or disassemble a portable stage.

These and other objects of the present invention will become more fully apparent as the description proceeds in the following specification and the attached drawings. These and other objects and advantages of the present invention, along with features of novelty appurtenant thereto, will appear or become apparent in the course of the following descriptive sections.

### BRIEF DESCRIPTION OF THE DRAWINGS

In the following drawings, which form a part of the specification and which are to be construed in conjunction therewith, and in which like reference numerals have been employed throughout wherever possible to indicate like parts in the various views:

FIG. 1 is a perspective view showing an exemplary embodiment in accordance with the invention herein;

FIG. 2 is a rear elevational view thereof illustrating the side walls in a closed position;

FIG. 3 is a rear elevational view thereof illustrating the side walls in an open position;

FIG. 4 is an environmental view thereof;

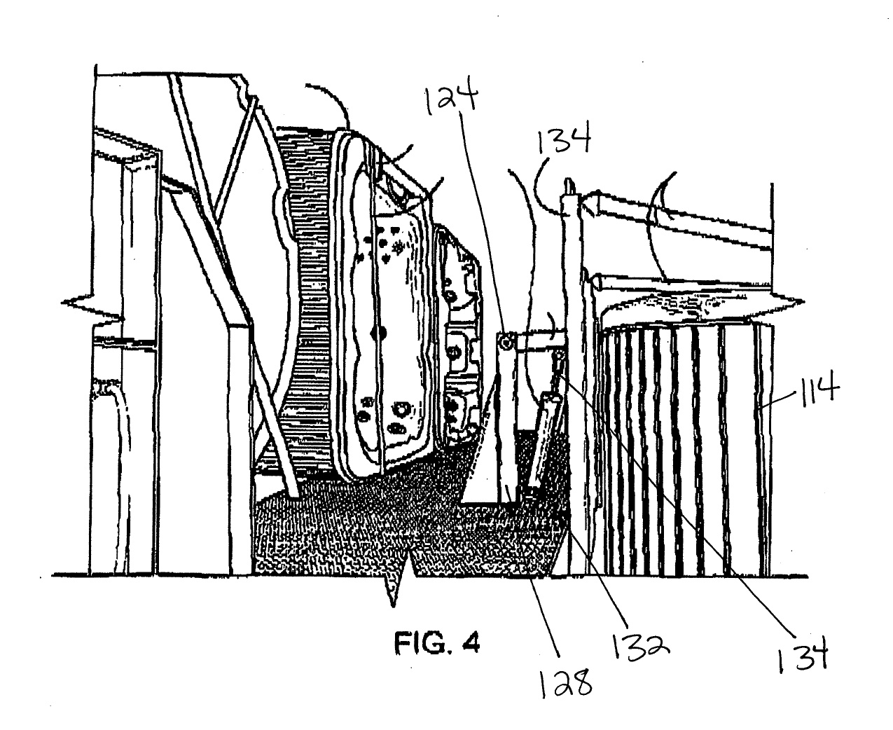

FIG. 5 is an environmental view thereof;

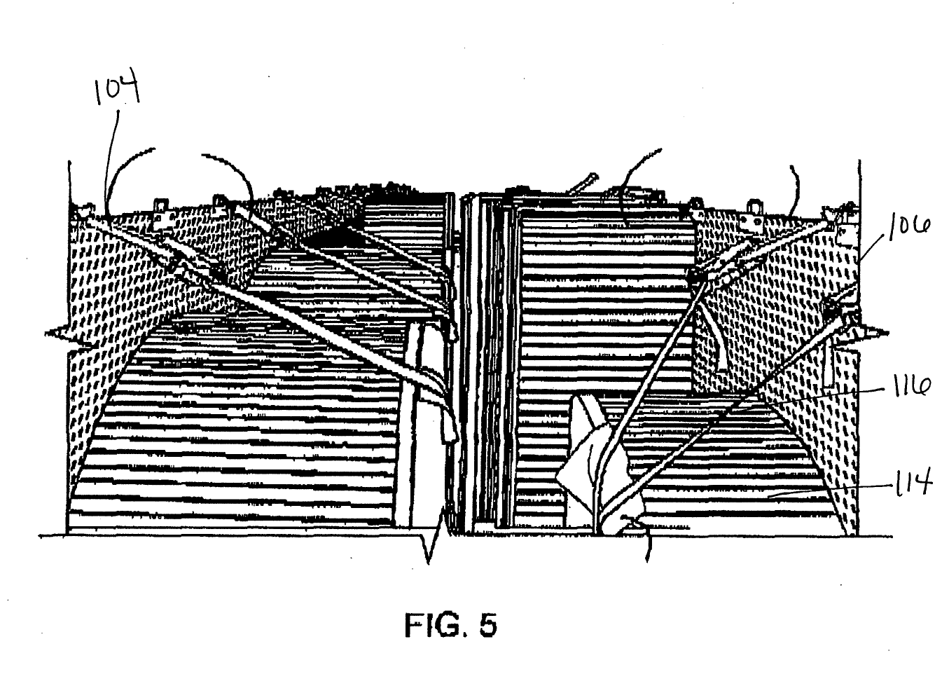

FIG. 6 is a perspective view of one embodiment of the present invention:

FIG. 7 is a rear elevational view of another embodiment of the present invention;

FIG. 8 is a rear elevational view of another embodiment of the present invention illustrating a top covering in a closed position;

FIG. 9 is an rear elevational view thereof illustrating a top covering in an open position; and

FIG. 10 is a schematic view of one embodiment of the present invention.

### DETAILED DESCRIPTION

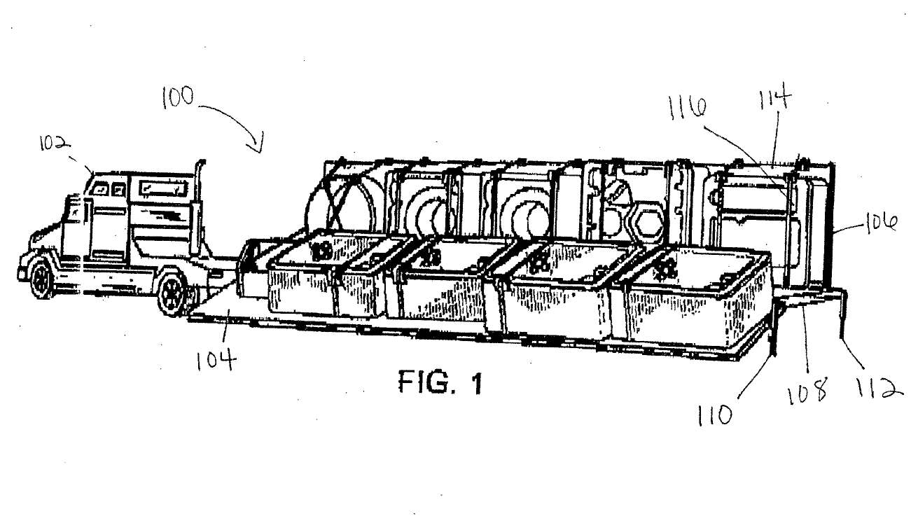

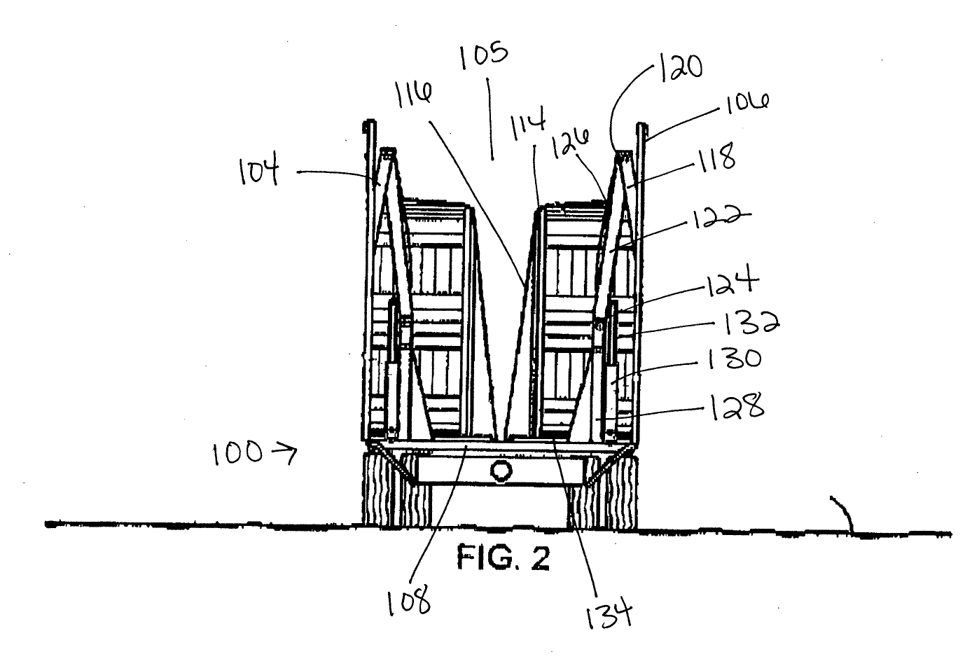

Referring to FIG. 1, a trailer of the present invention is generally indicated at 100. The trailer 100 of the present invention is releasably coupled to the tractor 102 for transporting goods. In one embodiment of the present invention, the present invention is designed to tote a number of spas 114. Tractors, such as tractor 102, are well known in the art and can be of any suitable type that allows the trailer 100 to be attached to the tractor 102 for hauling items such as spa 114. The trailer 100 defines a storage area 105, as shown in FIG. 2, for directly receiving the goods, such as spa 116, to be loaded in the present invention by a loading apparatus or other known methods of loading a trailer or vehicle. Each of the trailer 100 and tractor 102 includes a plurality of wheels for moving trailer 100 and tractor 102. The number of wheels of the trailer 100 depends upon the dimensions of the trailer 100.

It will be appreciated by those having ordinary skill in the art that the present invention can receive and transport a number of goods, articles, and other items that will fit inside storage area 105 of the present invention. It will be appreciated also that the trailer 100 and tractor 102 of the present invention can have any suitable size and structural relationship with respect to each other.

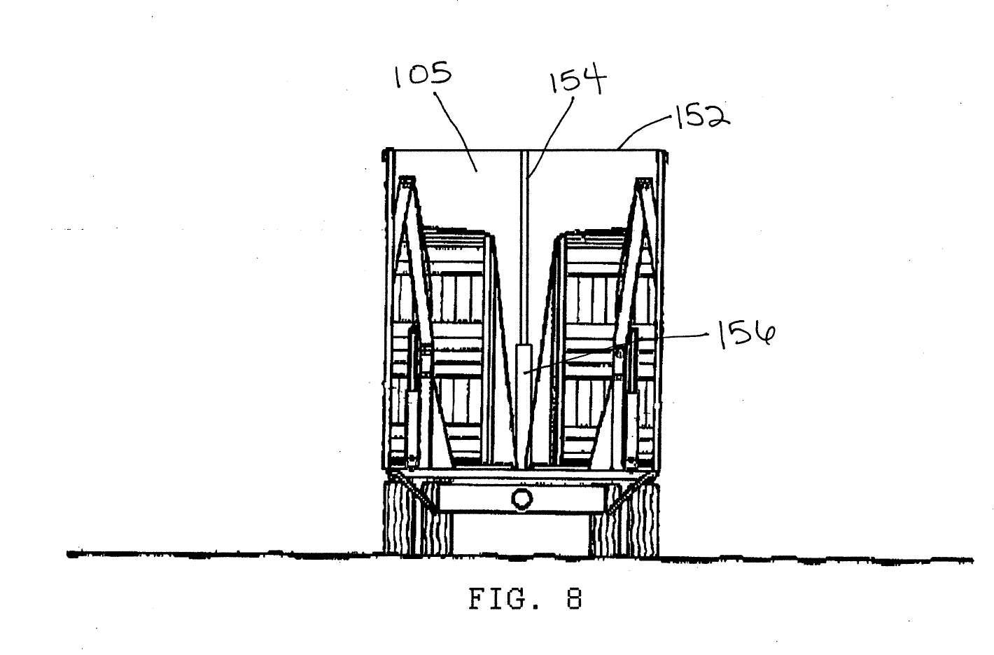

Still referring to FIG. 1, the trailer 100 includes, in general, a bed bottom 108 and at least a pair of side walls 104, 106, adapted to substantially cover respective sides of the storage area 105. In another embodiment of the present invention, the present invention utilizes a top covering 152, shown in FIG. 8, spaced from the bed bottom 108 and adapted to substantially cover storage area 105. In the embodiment with the top covering 152, top covering 152 is connected to a lifting system that supports and lifts the top covering such that side walls 104, 106 can be raised and lowered. In one embodiment of the present invention, the top covering 152 is coupled to at least one actuator, such as a hydraulic cylinder, that lifts and supports the top covering. In the embodiment of the present invention that utilizes the top covering 152, the top covering 152 is attached to a secondary lifting arm securely attached to bed bottom 108. Hydraulic lines connected to the at least one secondary hydraulic cylinder provide hydraulic fluid to the secondary hydraulic cylinders to raise the secondary lifting arm to raise the top covering 152 to an open position. As hydraulic fluid is removed from the secondary hydraulic cylinder, the top covering 152 lowers to a closed position. The raising and lowering of top covering 152 will be described in greater detail below.

At least one side wall 104 of the pair of side walls 104, 106 are movable relative to the bed bottom 108 between a storage position and a load position. As shown in FIG. 1, side wall 104 is adjusted to a load position. On the other hand, side wall 106 is adjusted to a storage position. The load position and storage position of side walls 104, 106 will be described in greater detail below.

As shown in FIG. 1, one embodiment of the present invention utilizes stabilizers 110, 112 to support the trailer 100 of the present invention. The present invention further utilizes stabilizers at the front of trailer 100. In one embodiment of the present invention, the stabilizers are stored in a transport state while the present invention is mobile. When the user has found a location for displaying the goods, the user parks the present invention and stabilizes the present invention with stabilizers 110, 112 and the stabilizers stored in the front of the trailer 100. In one embodiment of the present invention, a user lowers the stabilizers 110, 112 such that stabilizers 110, 112 contact the ground. After the stabilizers 110, 112 contact the ground, the present invention utilizes a threaded rod, similar to a threaded rod found in a jack, to maintain the required pressure needed to stabilize the present invention. A user simply utilizes the crank to adjust the jack such that stabilizers 110, 112 supply the necessary pressure to stabilize the present invention. To raise the stabilizers 110, 112 to allow relocation of the present invention, a user cranks in the opposite direction to raise the stabilizers to a transport mode. As is known in the art, other methods of securing the stabilizers can be utilized by the present invention. Such other methods may include a hydraulic jack, a bolting system that secures the stabilizers in place, or other methods known in the art.

As shown in FIG. 2, side walls 104, 106 are in a store position. Side walls 104, 106 and bed bottom 108 provide users with storage area 105 to allow storage of the goods to be transported. In one embodiment of the present invention, the present invention is designed to transport spas 114 secured to side wall 106 by webbing 116. Similarly, a user can store spas on side wall 104. Because side wall 104 and side wall 106 share similar structure and functionality, the structure and functionality of side wall 106 will now be explained with the understanding that side wall 104 works in a similar manner.

Side walls 104, 106 are attached to an actuator that raises one or both side walls 104, 106. In one embodiment of the present invention, the actuator is designed to raise or lower only one side wall at a time. In another embodiment of the present invention, the actuator can raise or lower both side walls 104, 106 at the same time. In one embodiment of the present invention, the actuator is a hydraulic lift that utilizes hydraulic cylinder 130 attached to a lifting arm 122 that is pivotally attached to side wall 106. In one embodiment of the present invention, side wall 106 is pivotally attached to lifting finger 118 which is pivotally attached to lifting arm 122 at pivot 120 which is pivotally attached to lifting base 128 at pivot 124. Lifting base 128 is fixedly attached to bed bottom 108. Hydraulic cylinder 130 is fixedly attached to lifting arm 122 such that hydraulic cylinder 130 applies pressure to lifting arm 122 to raise and lower side wall 106. In one embodiment of the present invention, a bracket is welded to lifting arm 122 and piston 132 is attached to the bracket by a pin such that cylinder 132 can support lifting arm 122 during the raising and lowering of side wall 106.

The present invention utilizes an actuator, such as a hydraulic system, to raise and lower the side walls 104, 106. Hydraulic systems are well known in the art, and, therefore, those having ordinary skill in the art will readily understand this system and its possible variations.

One embodiment of the present invention utilizes a reversible motor to provide hydraulic fluid under pressure. The reversible motor, which may be a truck engine starter motor, is connected to a gear type hydraulic pump by two different sets of so that hydraulic fluid may be pumped in two directions. In another embodiment, two separate motors can be utilized such that this embodiment of the present invention does not require a reversible motor. Extending from the hydraulic pump is a hydraulic line, which is connected to a reservoir for hydraulic fluid. Another hydraulic line extends from the hydraulic reservoir and through a valve into a hydraulic line, which is connected into hydraulic cylinder 130. In another embodiment of the present invention, the hydraulic cylinders are provided hydraulic fluid through the tractor's 102 hydraulic system.

Another hydraulic line also extends from the hydraulic pump through the valve, but it is connected to a hydraulic line which extends into the other sides of the hydraulic cylinders 130. Of course, as is well known in the art, by using such a hydraulic system as described herein, the piston 132 may be extended and retracted, with respect to the hydraulic cylinders 130, by controlling the entry of hydraulic fluid under pressure into hydraulic lines. In one embodiment, the present invention utilizes multiple hydraulic cylinders requiring multiple hydraulic lines to the valve and to the other hydraulic cylinders. In addition, multiple hydraulic lines connect the hydraulic cylinders to the reservoir. Further, multiple actuators may be implemented in the present invention to support the weight of side walls 104, 106.

More specifically, the present invention includes at least one cylinder and, preferably, a pair of cylinders 130 disposed at the front and rear of trailer 100 attached to side walls 104, 106. The hydraulic cylinders 130 are configured to hydraulically move, respectively, the movable side walls 104, 106. In another embodiment, hydraulic cylinders are utilized to lift the top covering 152 of the present invention. Each cylinder 130 has a piston 132 that is forced outwardly from the cylinder 130 to raise side wall 106. The piston 132 is also pulled inwardly into the cylinder 130 to move the movable side wall 106 downwardly and inwardly. In a like manner, each cylinder 130 has a piston 132 that is forced outwardly from the cylinder 130 to exert force on lifting arm 122 to raise side walls 104, 106.

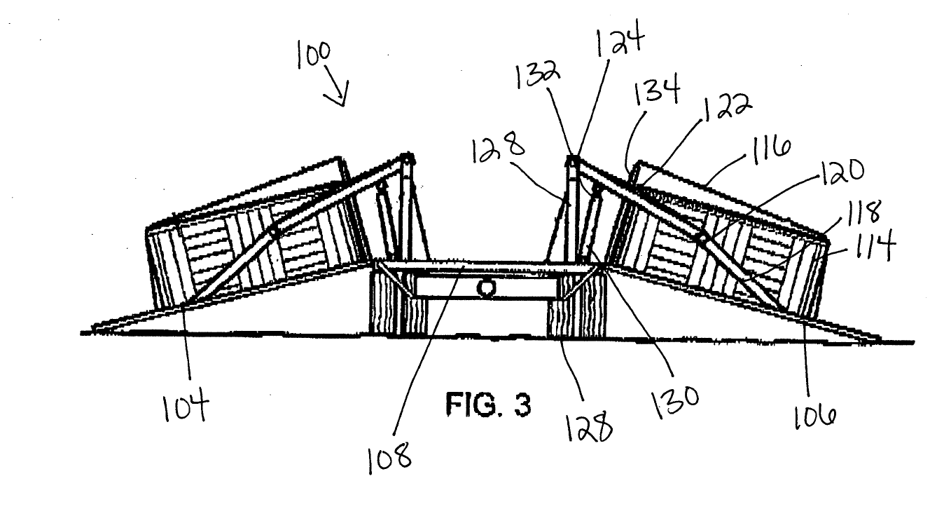

When it is desired to load, unload, or display the transported items such as spa 114 or other transported items on to the present invention, hydraulic fluid is applied under pressure through hydraulic lines causing the pistons 132 to retract so that side walls 104 or 106 are pivoted downward from the position in FIG. 2 to the position in FIG. 3 where the side walls 104 and 106 extend toward the ground.

When it is desired to load items such as spas or other transported items to transport the items, hydraulic fluid is applied under pressure through hydraulic lines causing the pistons to extend such that side walls 104 and 106 pivot to the storage mode so that the loaded items will be securely stored within the present invention. The hydraulic system of the present invention exerts enough force on side walls 104, 106 such that side walls 104, 106 will raise and support the loaded items while the items are stored within the present invention.

The present invention utilizes a controller to adjust the positioning of side walls 104, 106 between a storage and load position. The controller controls the hydraulic system to exert pressure on the lifting arm 122 such that lifting arm 122 raises and lowers side wall 106 according to the controller input. A motor of the present invention controls the hydraulic fluid to flow through the hydraulic lines to hydraulic cylinder 130. As the hydraulic fluid flows to the hydraulic cylinder 130, hydraulic fluid exerts a force on piston 132 such that piston 132 exerts a force upon lifting arm 122 and side wall 106. As the lifting arm 122 raises side wall 106, lifting finger 118 pivots causing side wall 106 to adjust to storage position as seen in FIG. 2.

The transformation of the present invention shown in FIG. 2 to FIG. 3 shows the adjustment of side wall 106 from a storage position to a load position. To lower side wall 106, the hydraulic system gradually transfers hydraulic fluid away from hydraulic cylinder 130 through the hydraulic lines to a reservoir 172. As hydraulic fluid is transferred from the hydraulic cylinder 130 through the hydraulic lines, the hydraulic fluid exerts less pressure on piston 132 such that piston 132 gradually retracts into hydraulic cylinder 130. Hydraulic fluid gradually flows away from hydraulic cylinder 130 such that the side wall lowers side wall 106 at a rate that will not destroy or damage the transported goods.

As side wall 106 lowers, hydraulic cylinder 130 pivots with lifting arm 122 such that hydraulic cylinder 130 will constantly exert force on lifting arm 122. By pivoting with lifting arm 122, hydraulic cylinder 130 maintains control of the raising and lowering of side wall 106 to lower side wall 106 at an adequate rate.

The lifting base 128 of the present invention is securely attached to bed bottom 108 such that lifting base 128 supports lifting arm 122 as hydraulic cylinder 130 lowers lifting arm 122. In one embodiment of the present invention, the lifting base 128 is shaped as a triangular prism to support the raising and lowering of sidewalls 104, 106. Other shapes of the lifting base 128 can be utilized to support the lifting arm 122. Hydraulic cylinder 130 lowers lifting arm 122 such that side wall 106 is transferred from a storage position to a load position. The hydraulic cylinder 130 is attached to hydraulic lines such that hydraulic fluid is applied to cylinder 130. As the motor of the present invention transfers hydraulic fluid away from hydraulic cylinder 130, the pressure in hydraulic cylinder 130 decreases such that piston 132 retracts into hydraulic cylinder 130 causing side wall 106 to lower such that the items such as spa 114 can be loaded, unloaded, or displayed from the present invention.

When loading the present invention as shown in FIG. 3, side wall 106 provides securing arm 134 to support the transported items, such as spa 114 during the loading and unloading process. Securing arm 134 is securely attached to side wall 106 such that securing arm 134 supports the weight of the loaded items, such as spa 114, while the items are transferred into the present invention. As shown in FIG. 3, securing arm 134 provides webbing 116 that secures the transported items, such as spa 114, to side wall 106. As is known in the art, the webbing 116 can be a tie down system, a ratcheting system, such as ratchet straps, bungee cords, or other known systems to secure items. As shown in FIG. 3, side wall 106 provides an area to attach the webbing 116 to side wall 106 to secure spa 114 to side wall 106. The webbing 116 of the present invention prevents the transported items, such as spa 114, from shifting during transportation. The fastening system allows a user to safely load and unload the trailer while eliminating the possible damage that may occur to spa 114.

In one embodiment of the present invention, a hydraulic system raises and lowers side walls 104, 106. The hydraulic system includes hydraulic cylinder 130 which is pivotally mounted to the bed bottom 108 by the pivotal connection found at the base of hydraulic cylinder 130. A piston 132 is slidably, sealably mounted for slidable movement within the hydraulic cylinder 130.

In one embodiment of the present invention, the controller is a hydraulic system used to control the rotation of each of the movable side walls 104, 106 and top covering 152. Hydraulic systems are well known in the art, and, therefore, those having ordinary skill in the art will readily understand this system and its possible variations.

When pivoting the side walls 104, 106 from a load position shown in FIG. 3 to a storage position as shown in FIG. 2, hydraulic fluid is transferred to hydraulic cylinder 130 such that piston 132 extends from hydraulic cylinder 130. As piston 132 extends from hydraulic cylinder 130, piston 132 raises lifting arm 122. Hydraulic cylinder 130 pivots towards toward the central storage area 105 until it forms a 90 degree angle with bed bottom 108.

As side wall 106 pivots to the storage position, securing arm 134, which is fixedly attached to side wall 106, supports spa 114, or other transported items, such that spa 114 remains secured to side wall 106 during the transfer process in which side wall 106 adjusts from a load position to a storage position.

As piston 132 extends from hydraulic cylinder 130, piston 132 exerts force on lifting arm 122 such that lifting arm 122 lifts side wall 106. Pivot 120 allows lifting finger 118 to pivot in relation to lifting arm 122 to raise side wall 106. Further, lifting finger 118 pivots in relation to side wall 106 to allow the hydraulic system to lift side wall 106. Lifting arm 122 and lifting finger 118 pivot in relation to each other to allow piston 132 to lift side wall 106 such that piston 132 maintains pressure on side wall 106 to prevent jarring movement of side wall 106 that may damage the transported items, such as spa 114.

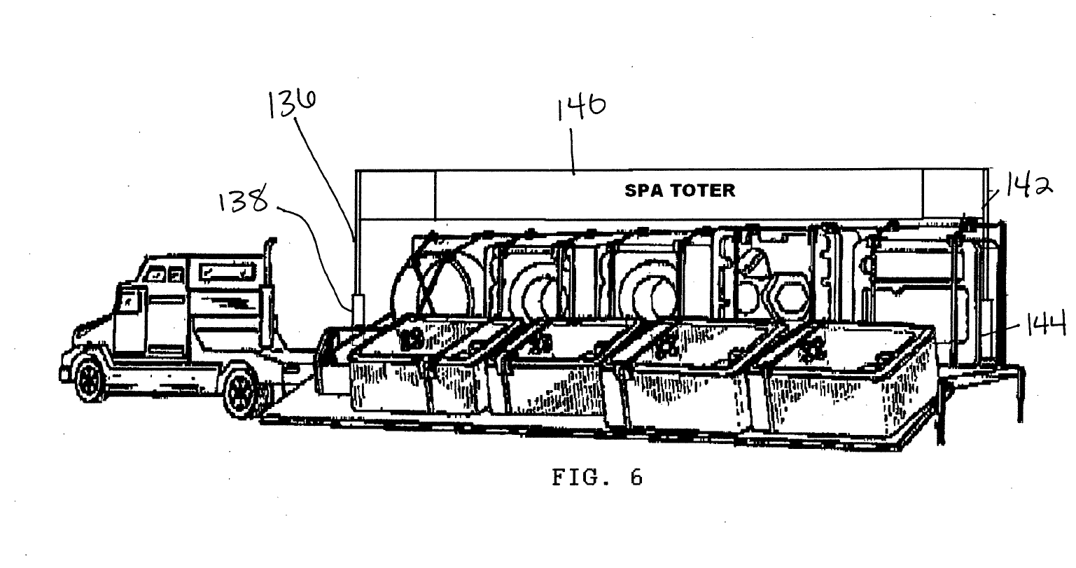

As shown in FIG. 6, one embodiment of the present invention utilizes secondary hydraulic cylinders that are fixedly attached to bed bottom 108. Hydraulic lines connected to the secondary hydraulic cylinders provide hydraulic fluid to secondary hydraulic cylinders to raise and lower the secondary lifting arms.

In one embodiment of the present invention as shown in FIG. 6, a user fastens banner 140, display, or advertisement to the two secondary lifting arms 136, 142. After a user assembles the mobile display, a user can raise the secondary lifting arms 136, 142 such that the banner 140, display, or advertisement will be shown in a more prominent manner that attracts potential customers. A user of the present invention utilizes the controller to provide hydraulic fluid to the secondary hydraulic cylinders 138, 144 such that the secondary hydraulic cylinders 138, 144 will raise secondary lifting arms 136, 142. After secondary lifting arms 136, 142 are fully extended, the present invention fully displays the banner 140, display, or advertisement that a user has secured to the secondary lifting arms 136, 142.

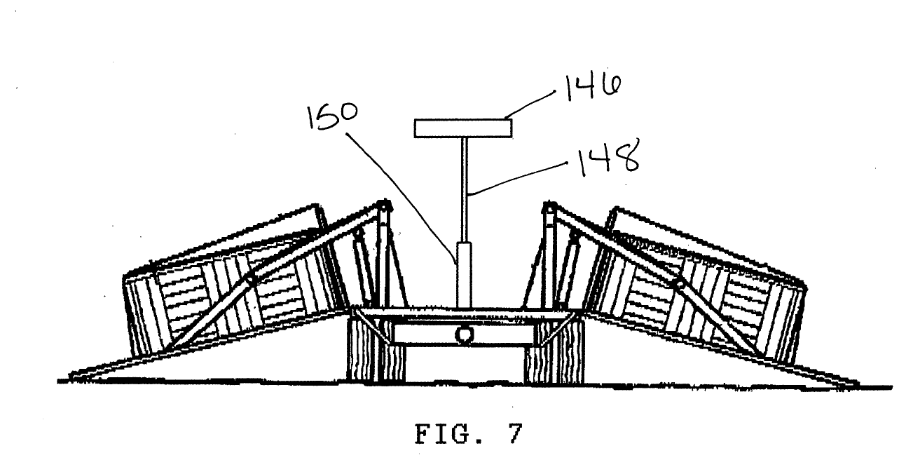

In another embodiment of the present invention as shown in FIG. 7, lights 146 are mounted to the secondary lifting arms 148. The lights 146 mounted to the secondary lifting arms 148 provide sufficient lighting to the mobile display to increase the operating hours in which a user can prominently display goods such as spa 114. Multiple secondary lifting arms can be installed to provide adequate lighting for a mobile display.

When a user changes locations, the user simply lowers the secondary lifting arms 136, 142 such that the banner 140, display, or advertisements will be stored within storage area 105. As is known in the art, the secondary lifting arms 136, 142 may be raised or lowered in other known methods such as a mechanical jack, lifting and bolting the system, and other methods known in the art.

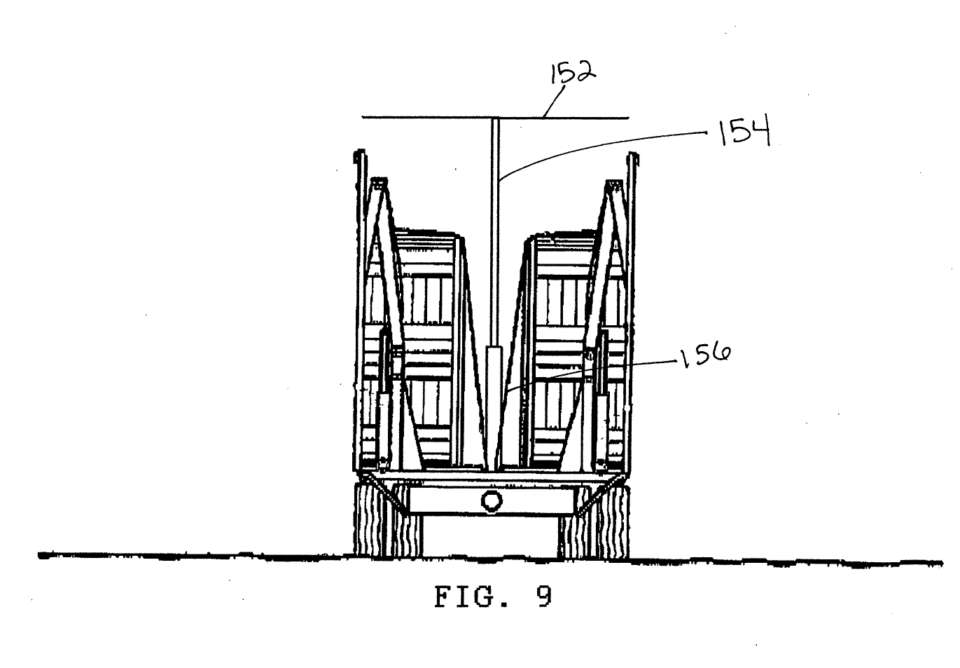

FIGS. 8-9 show another embodiment of the present invention in which a top covering encloses storage area 105. In the embodiment of the present invention that utilizes a top covering 152, a top covering 152 is attached to secondary lifting arms 154 supported by secondary hydraulic cylinder 156. A similar secondary lifting arm and secondary hydraulic cylinder is located at the front of the present invention. In this embodiment of the present invention, the secondary lifting arms 154 must be constructed of a rigid material that supports the weight of the top covering 152.

FIG. 8 shows the top covering 152 in a closed position in which the top covering 152 encloses storage area 105. To raise the top covering 152, a user accesses the controller to provide hydraulic fluid to secondary hydraulic cylinder 156. The motor of the present invention provides hydraulic fluid to the secondary hydraulic cylinders 156 to raise the top covering 152. As hydraulic fluid is provided to the secondary hydraulic cylinders 156, secondary lifting arms 154 extend from the hydraulic cylinders 156 to raise the top covering 152. The secondary lifting arms 154 are securely attached to the top covering 152. As the secondary lifting arms 154 extend from the secondary hydraulic cylinders 156, the secondary lifting arms 154 raise the top covering 152 to expose the central storage area 105 of the present invention as shown in FIG. 9.

To lower the top covering 152 as shown in the transition from FIG. 9 to FIG. 8, a user selects to lower the top covering 152 with the controller. The motor of the present invention transfers hydraulic fluid away from the secondary hydraulic cylinders 156 such that the secondary lifting arms 154 gradually retract into the secondary hydraulic cylinders 156. The secondary lifting arms 154 lower top covering 152 until the top covering 152 is flush with side walls 104, 106 such that top covering 152 encloses the central storage area 105.

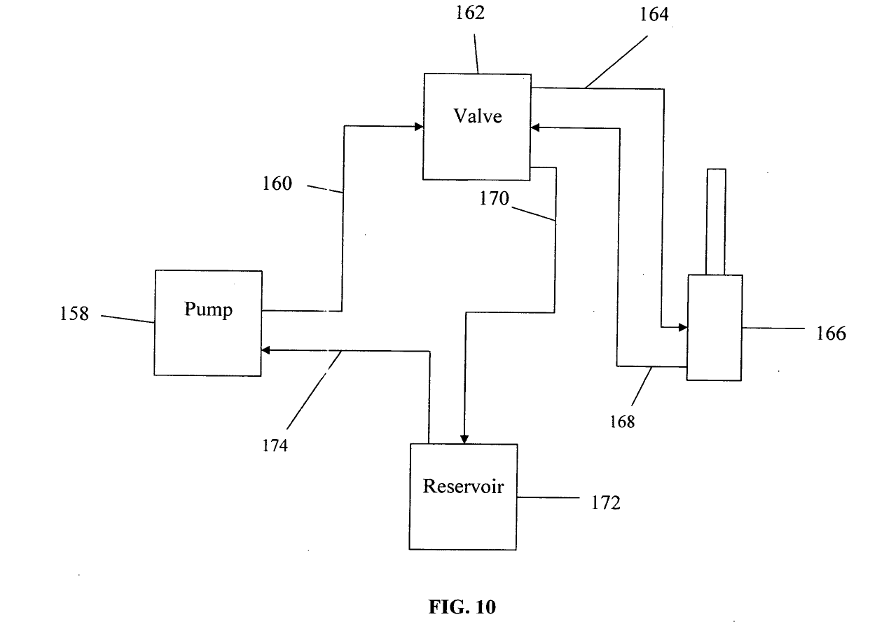

FIG. 10 shows a schematic view of one embodiment of the present invention. As shown in FIG. 10, pump 158 draws hydraulic fluid from reservoir 172 through hydraulic line 174. Pump 158 supplies the hydraulic fluid to valve 162 through hydraulic line 160. The present invention utilizes valve 162 to control the direction in which the hydraulic fluid flows. As shown in FIG. 10, hydraulic lines 164, 168 connect valve 162 to hydraulic cylinder 166. Two hydraulic lines connect valve 162 to hydraulic cylinder 166. In other embodiments of the present invention, additional hydraulic cylinders are used such that additional hydraulic cylinders are connected to valve 162. Hydraulic lines 164, 168 supply hydraulic fluid to and from hydraulic cylinder 166 to allow the piston of hydraulic cylinder 166 to rise and lower. In addition, valve 162 supplies hydraulic fluid to reservoir 172 through hydraulic line 170 to allow piston of hydraulic cylinder 166 to lower.

In another embodiment of the present invention, the present invention is utilized to assemble a portable stage. A user of the present invention parks the present invention in a location in which the user wishes to assemble a portable stage. The user accesses the controller to lower the side walls 104, 106 to a position level with the bed bottom 108. The hydraulic cylinders 130 and pistons 132 support the side walls 104, 106 such that the lifting arms 122 will maintain the side walls 104, 106 at a position level with bed 108.

Because of the versatility of which side walls 104, 106 can be raised and lowered, a user of the present invention can create multiple types of stages. A user can lower the side walls 104, 106 to a position level with the bed bottom 108 such that a user can park multiple trailers of the present invention beside each other to increase the size of the portable stage.

A user can also lower one side wall 104 to the ground to create a ramp to the bed bottom 108. The user can keep the other side wall 106 raised to create a back drop to the portable stage. Multiple variations of stage settings can be used by raising and lowering of side walls 104, 106.

The present invention also provides a new method by which a user can sell large items such as spa 114. A user of the present invention is enabled with a portable display from which the user can display the actual goods to potential customers. Instead of showing pictures or advertisements of the goods, a user of the present invention shows the actual goods so that a user can grasp the size of the item and the features that can be displayed to the user in person, instead of relying upon a description of the features of the item.

A user of the present invention stocks the present invention with the goods to be sold. A user then travels to an area in which he wishes to assemble a portable display for the goods. A user will search for a high traffic area in which potential customers will be drawn to the portable display. After finding a location, the user can lower the side wall 104, side wall 106, or both side walls 104, 106 to create the desired display. A user can lower the side wall 104, 106 to the ground or lower side wall 104, 106 to be level with bed bottom 108. After assembling the desired display, a user can raise a banner 140 to draw additional customers to the portable display. As described earlier, a user raises banner 140 by raising secondary lifting arms 136, 142. As described earlier, the user can raise the secondary lifting arms 136, 142 with a hydraulic lift or the user can manually raise banner 140.

In another embodiment of the present invention, the user can draw greater attention to the portable display by lighting the portable displays with lights 146. The present invention provides a generator, battery power, or other power source to provide electricity to lights 146

By way of specific example, the hydraulic cylinders 130 used to raise and lower the side walls 104, 106 and the sealed mounting of the pistons 132 within the cylinders 130 are capable of withstanding pressures of approximately 3,000 P.S.I. The storage tank is a three gallon tank storing hydraulic fluid and all the lines are typical hydraulic hoses also able to withstand the above mentioned pressures. The motor is a 12 volt direct current motor with integral pump capable of pumping 8 to 9 gallons per minute. In another embodiment, a generator supplies power to a 120 volt motor. It is understood that these examples of specific details are given by way of illustration and that it is within the scope of the present invention to adapt different variations of the specific details to supply the necessary pressure to raise and lower side walls 104, 106.

From the foregoing, it will be seen that the present invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A trailer apparatus for transporting at least one item, the apparatus comprising:
a bed having a bed bottom and at least one side wall;
the at least one side wall having a lower edge pivotally attached to an adjacent edge of the bed bottom to permit the side wall to be opened downwardly to provide side access to the bed;
a lifting arm attached to the bed bottom and attached to the at least one side wall, the lifting arm adapted to pivot the side wall in relation to the bed bottom; and
an actuator attached to the lifting arm wherein the actuator applies force to the lifting arm to raise and lower the side wall.

2. The apparatus of claim 2 further comprising:
at least one support arm attached to the side wall, the support arm adapted to pivot with the side wall.

3. The apparatus of claim 2 further comprising:
webbing adapted to secure the item to the at least one side wall wherein the webbing is releasably secured to the side wall and the at least one support arm.

4. The apparatus of claim 1 further comprising:
a second side wall wherein the second side wall is pivotally attached to an adjacent edge of the bed bottom to permit the second side wall to be opened downwardly;
a second lifting arm attached to the second side wall and the bed bottom wherein the second lifting arm is adapted to raise and lower the second side wall; and
a second actuator attached to the second lifting arm wherein the second actuator applies force to the second lifting arm to raise and lower the side wall.

5. The apparatus of claim 4 wherein the second actuator is a hydraulic cylinder attached to at least one hydraulic line that supplies hydraulic fluid to the hydraulic cylinder to cause movement of a piston attached to the second lifting arm.

6. The apparatus of claim 1 wherein the lifting arm is pivotally attached to a lifting base securely attached to the bed bottom.

7. The apparatus of claim 6 wherein the lifting arm is pivotally attached to a lifting finger pivotally attached to the sidewall.

8. The apparatus of claim 1 wherein the actuator is a hydraulic cylinder attached to at least one hydraulic line that supplies hydraulic fluid to the hydraulic cylinder to cause movement of a piston attached to the lifting arm.

9. The apparatus of claim 1 wherein the actuator is pivotally attached to the bed bottom.

10. The apparatus of claim 1 further comprising a secondary actuator fixedly attached to the bed bottom wherein the secondary actuator is adapted to raise and lower a secondary lifting arm.

11. The apparatus of claim 10 wherein the secondary lifting arm is adapted to display an advertisement.

12. The apparatus of claim 10 wherein the secondary lifting arm is attached to a top covering wherein the secondary lifting arm is adapted to raise and lower the top covering.

13. A trailer apparatus comprising:
a bed having a bed bottom and at least one side wall;
the at least one side wall having a lower edge hingedly connected to an adjacent edge of the bed bottom to permit the side wall to be opened downwardly to a position level with the bed bottom;
a lifting arm attached to the bed bottom and attached to the at least one side wall, the lifting arm adapted to pivot the side wall in relation to the bed bottom; and
an actuator attached to the lifting arm wherein the actuator applies force to the lifting arm to raise and lower the side wall.

14. The apparatus of claim 13 wherein the actuator is adapted to exert force to support the side wall at a position level with the bed bottom.

15. The apparatus of claim 13 further comprising at least one stabilizer adapted to stabilize the bed bottom by exerting a force on the ground and the bed bottom.

16. The apparatus of claim 13 wherein the actuator is a hydraulic cylinder attached to at least one hydraulic line that supplies hydraulic fluid to the hydraulic cylinder to cause movement of a piston attached to the lifting arm.

17. The apparatus of claim 13 wherein the actuator is pivotally attached to the bed bottom.

18. A method of selling items comprising:
stocking at least one item to be sold within a trailer;
locating an area to assemble a portable display to sell the at least one item;
parking and stabilizing the portable display; and
lowering a side wall of the trailer to display the item to be sold.

19. The method of claim 18 further comprising:
securing the item to a side wall of the present invention to display the item when the side wall is lowered.

20. The method of claim 19 wherein the item to be sold is a spa.
